(19) United States
(12) Patent Application Publication
(10) Pub. No.: US 2007/0056683 A1
(43) Pub. Date: Mar. 15, 2007

(54) Strap/inlay insertion method and apparatus

(75) Inventors: Kevin Stone Manes, St. Charles, MO (US); John B. Howard, Wildwood, MO (US)

Correspondence Address: FOLEY AND LARDNER LLP;SUITE 500, 3000 K STREET NW, WASHINGTON, DC, 20007, US

(73) Assignee: DELAWARE CAPITAL FORMATION, INC.

(21) Appl. No.: 11/517,576

(22) Filed: Sep. 8, 2006

Related U.S. Application Data
(60) Provisional application No. 60/715,172, filed on Sep. 9, 2005.

(51) Int. Cl. B32B 37/00

(52) U.S. Cl. 156/264; 340/572.7

(57) ABSTRACT

An apparatus and a method are disclosed for forming an electrical component construction, the method comprising: obtaining a chip webstock containing a plurality of integrated circuit chips; obtaining a label webstock having printed label graphics thereon; cutting the chip webstock into a plurality of chip sections, each of the chip sections including at least one integrated circuit chip; indexing the chip sections from a high density on the chip webstock to a lower density; attaching each of a plurality of the different chip sections on a different label on the label webstock; obtaining an electrical component webstock comprising electrical components on a web; and attaching each of a plurality of the electrical components relative to a different one of the integrated circuit chips on the label webstock to permit an electrical communication therebetween.

### CROSS-REFERENCE TO RELATED PATENT APPLICATIONS

This application claims priority from Provisional Application US Application 60/715,172 filed Sep. 9, 2005, incorporated herein by reference in its entirety.

### FIELD OF THE EMBODIMENTS

The present invention relates to a process and apparatus for mounting integrated circuit chips (IC's) to facestock and then subsequently marrying or mounting an electrical component to each of the chips to permit an electrical communication therebetween. More specifically, the invention is directed toward a method of mass-producing devices, such as in one embodiment, radio frequency identification tags or labels (RFIDs).

### BACKGROUND OF THE INVENTION

The method and apparatus of the present invention is found to be particularly useful, but is not limited to, the formation of labels having radio frequency (RF) devices such as RFIDs disposed thereon. Such RFID devices can be used for inventory management, highway toll express passes, hospital control, and for many other purposes.

There are a variety of integrated circuit (IC) chip configurations that can be mounted using the process and/or apparatus of the present invention. In one embodiment, individual IC chips can be directly placed or mounted on an antenna or other electrical component.

A further IC chip configuration that can be mounted is referred to as a strap and comprises an integrated circuit chip disposed on large conductive contact pads on a polymeric or paper substrate. The strap is then attached across a gap between two conductive surfaces of a thin conductive film antenna or across the contact pads of an electrical component. In an RFID label configuration, the IC contains encoded data for identification purposes. The IC and the antenna act together as a transponder, which receives an RF signal and modifies it according to the data encoded on the IC.

The U.S. Pat. No. 6,891,110 to Pennaz discloses in FIG. 1 one embodiment of a strap and is hereby incorporated by reference in its entirety. The strap is shown designated as 30. Each strap 30 includes an integrated circuit chip 10 disposed on a thin substrate 32 having two conductive ink pads 34 and 36 printed thereon. These pads 34 and 36 provide a larger effective electrical contact area and mitigate the precise alignment requirement for direct placement of the IC chip on the antenna or other electrical component or vice versa. The larger area of the contact pads reduces the accuracy required for placement of ICs during manufacture while still providing effective electrical connection. The substrate for the strap, in one embodiment, is coated with a pressure sensitive conductive adhesive that allows an IC to be electrically and mechanically mounted across the conductive ink pads of the antenna or other electrical component.

In previous RFID-IC-chip-attach-to-label processes, the strap webstock, or in some cases an inlay webstock comprising an already-mounted RFID chip and antenna combination, were applied to a vacuum drum, die cut using a die cutting roll, and then the resulting cut straps or cut inlays were held to the vacuum drum by the vaccum holes in the vacuum drum until applied to the label webstock. For example, see FIG. 3C of U.S. Pat. No. 6,772,663 to Machamer, and FIGS. 7-10 and 13-14 of U.S. Pat. No. 6,451,154 to Grabau et al., both of which patents are hereby incorporated by reference in their entireties.

However, previous processes for attaching straps to label facestock that had a plurality of antennas printed thereon did not allow use of common pressure sensitive label stock as the base substrate due to an inability to print on the adhesive surface of the label. Such processes required the use of a C2S substrate, i.e., paper or other substrate coated on both sides to permit printing of the labels on one side and the printing of the antennas on the other side, with a subsequent coating of an adhesive and a lamination of a separate silicone release liner.

The previous process also required reverse-side printing of the conductive antenna onto the label facestock to prevent obscuring the label printing. But printing the antenna directly onto the back side of the label facestock requires the chip side of the strap to contact the facestock at the antenna location, resulting in a raised “bump” appearance on the label in the area of the chip.

### SUMMARY OF THE INVENTION

In one embodiment, a method is disclosed for forming an electrical component construction, comprising: obtaining a chip webstock containing a plurality of integrated circuit chips; obtaining a label webstock having printed label graphics thereon; cutting the chip webstock into a plurality of chip sections, each of the chip sections including at least one integrated circuit chip; indexing the chip sections from a high density on the chip webstock to a lower density; attaching each of a plurality of the different chip sections on a different label on the label webstock; obtaining an electrical component webstock comprising electrical components on a web; and attaching each of a plurality of the electrical components relative to a different one of the integrated circuit chips on the label webstock to permit an electrical communication therebetween.

In a further embodiment, an apparatus is disclosed for forming an electrical construction, comprising: a cutting apparatus for cutting a chip webstock containing integrated circuit chips into a plurality of chip sections, each of the chip sections including at least one integrated circuit chip; a first vacuum drum designed to receive chip sections with a side with the integrated circuit chip facing a surface of the first vacuum drum, the first vacuum drum designed for indexing the chip sections from a high density of the chip webstock to a lower density, and at a nip attaching each of a plurality of the different chip sections adjacent to a different label on the label webstock; an electrical component attaching device for attaching or forming an electrical component on a substrate to form an electrical component webstock; and an attaching mechanism for attaching each of a plurality of the electrical components relative to a different one of the integrated circuit chips on the label webstock to permit an electrical communication therebetween.

### BRIEF DESCRIPTION OF THE DRAWINGS

FIG. 1 is a schematic diagram of a chip section comprising an electrical chip and contact pads in the prior art.

FIG. 2 is a schematic diagram of a first process and structure for forming an electrical construction.

FIG. 3 is a schematic diagram of a second process and structure for forming an electrical construction.

FIG. 4 is a schematic diagram of a specific embodiment of the invention comprising a label facestock with an electrical chip already attached being married to an antenna webstock, with a release liner subsequently being added.

FIG. 5 is a schematic diagram of one embodiment of an RFID label construction in accordance with the present invention.

### DETAILED DESCRIPTION OF THE PREFERRED EMBODIMENTS

In one embodiment of the invention, by adding a separate substrate on which antennas are printed, a common pressure sensitive label stock may be used as the base material, making the process less expensive and utilizing adhesives that have greater acceptance in the marketplace.

Additionally, when a separate antenna substrate (webstock) is provided, there is no need to reverse-side print the antenna onto the label facestock, thereby making the process easier to set up and the equipment requirements less expensive.

Additionally, by orienting the strap or inlay with the chip facing away from the label facestock, the strap or inlay substrate reduces the sharp stress points on the facestock, thereby reducing the “bump” effect of the chip.

Also, by placing a separate antenna substrate (webstock) over the strap, the chip has an additional layer of protection.

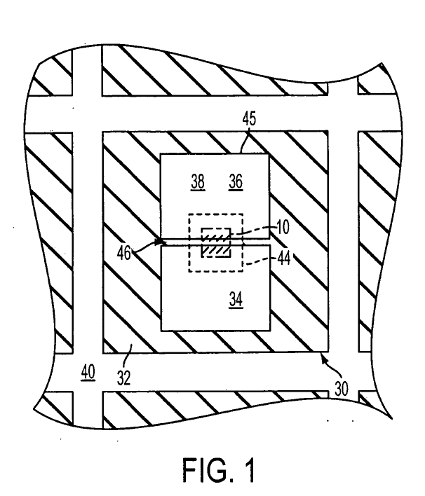

Referring now to FIG. 1, there is provided one embodiment of an integrated circuit webstock 30, referred to in the prior art as an interposer, or component section, or an RFID section, or a strap, to ease alignment for an IC chip and an electrical component, such as an antenna. As noted, the figure includes an integrated circuit chip 10, such as an RFID chip, in contact with one or more electrical contact pads 34 and 36 which provide a large effective electrical contact to reduce the accuracy required for placement of ICs during manufacture. The leading edge 45 of the printed pad 36 can serve as an alignment mark in printing and indexing (to be discussed below). A conductive adhesive film 38 secures the components of the device, such as an RFID tag. The conductive adhesive can be applied or printed over any conductor including metallized film, printed conductive inks (either carbon or silver or combinations thereof), foils or other conductors. Ideally, the same adhesive can be used to mount and hold the IC 10 that bonds the strap to the label. A pressure sensitive anisotropically conductive adhesive may be used in one embodiment to mount the IC 10 onto the substrate to form the strap 30, as well as to bond to the label. The conductive adhesive is preferably printable. The pressure sensitive adhesive film 38 will adhere the components together with an electrically conductive film that transmits current.

The conductive adhesive may also serve to hold the strap 30 to a liner 40, which allows handling of straps 30 in roll form to be applied as labels from reels. The adhesive properties of the conductive adhesive are adjusted with the liner to facilitate the handling of interposers during IC attachment and to provide release properties to allow mechanical insertion in high volume applications.

Note that FIG. 1 shows the substrate webstock 32 kiss-cut and disposed on a liner 40, so that the interposers 30 may be peeled off. However, in other embodiments of the invention, there would be no kiss-cut, but rather the substrate webstock 32 would be continuous and would be cut in a subsequent step to be discussed below.

In a different embodiment of the integrated circuit chip webstock, and in contrast to the design of FIG. 1, the IC webstock could comprise an inlay webstock with a plurality of inlays, each comprising an integrated circuit chip 10 already connected to a respective antenna, and with no or reduced size contact pads. For an example of such an integrated circuit chip, see U.S. Pat. No. 6,172,608 to Cole, which is hereby incorporated in its entirety into the present specification. A parasitic antenna would subsequently be placed on the label in proximity to the IC chip on the label, but not in electrical contact with the IC chip. The antenna in the Cole inlay would communicate with the parasitic antenna by means of electromagnetic coupling. The parasitic antenna would operate to customize the antenna range and antenna pattern for the device. It can thus be customized to a wide variety of different applications with different antenna requirements.

In one embodiment of the invention, IC chips individually, or in the form of the straps of FIG. 1, or in the form of the Cole inlay comprising an IC chip in combination with an antenna, are obtained on a webstock, cut into chip sections, and applied to a label webstock. Then an electrical component webstock is obtained and each of a plurality of the electrical components are attached on a label relative to a different one of the IC chips to permit an electrical communication therebetween.

In order to implement one embodiment of the invention with a separate antenna or other electrical component substrate (webstock), the IC chip webstock is applied with the IC chip, or straps or inlays placed upside down relative to previous processes on a vacuum drum. The IC chips, straps, or inlays are then cut into chip sections. The vacuum drum holds the resulting chip sections by means of vacuum holes in the vacuum drum that apply a negative pressure to the chip section. It has been discovered that this will present a problem with conventional vacuum drum designs since the IC chip itself (rather than the carrier substrate) covers and seals the vacuum holes/nozzles in the vacuum drum. Specifically, prior to the point an IC chip in the form of a strap or inlay is cut and separated from the web of straps or inlays, the strap webstock or inlay webstock must slide over the vacuum drum because the vacuum drum and the strap or inlay webstock are traveling at different speeds. This differential in speeds is due to the density of the straps or inlays and the need to index the pitch of the straps or inlays down to the pitch of the labels on the label facestock. However, this sliding over the vacuum drum requires the strap or inlay substrate to have a continuous, smooth surface to slide over from one vacuum hole to another vacuum hole. But with the chip side of the strap or inlay substrate in contact with the vacuum drum, the chips could be pulled from the substrate and would potentially break the vacuum seal as the irregular chip surface slides over the vacuum holes in the drum.

In one embodiment of the process, a bond tape is used to laminate onto the chip side of the straps or inlays so that the bond tape presents a smooth, continuous surface in contact with the vacuum drum.

In a further embodiment of the process, the vacuum drum would have a continuous relief formed around the circumference of the drum, allowing the chips to sit lower than the major surface of the vacuum drum on either side of the relief. The vacuum holes in the relief portion of the drum would create a suction with the edges of the strap or inlays where the surface is smooth and continuous.

In a further embodiment of the process, the functions of the single vacuum drum are separated into two different drums. The strap or inlay substrate would contact the first vacuum drum oriented with the chip side away from the drum. This would allow the drum surface of the first vacuum drum to travel at approximately the same velocity as the strap or inlay substrate, while the second vacuum drum would travel at a different velocity relative to the strap or inlay substrate, as is required prior to separation, without problem. More specifically, following separation from the strap or inlay substrate, the individual straps or inlays would be transferred to a second vacuum drum. There are several ways the straps or inlays might be transferred from one vacuum drum to another. One method might transfer the strap or inlay by direct contact from one drum to another. Another transfer method might be vacuum needles such as used in flip-chip integrated circuit placement. When the strap or inlay is transferred to the second vacuum drum, it would be placed chip side down, in contact with the drum. Since the strap/inlay and drum would be traveling at the same surface velocity, there would be no problem holding the chip side in contact with the drum. Because the separation (cutting) of the individual strap or inlay from the strap or inlay substrate occurs on the first drum, there is no need for the second drum to be constructed of hardened steel. The second drum may be fabricated with a surface of flexible material that would facilitate a vacuum seal to an irregular surface. Because the second drum would not be hardened metal and could be of lower precision, it would be less expensive than required by processes. Because the first vacuum drum provides only the cutting function, it does not require a large circumference to match velocity and accumulate multiple repeats of straps. Such a drum would be smaller and less expensive than required by previous processes.

In a yet further embodiment, building on the process of the previous paragraph, the cutting function of the first vacuum drum might be replaced with a simpler cutting mechanism such as a guillotine knife.

In one embodiment of the process and apparatus, the antenna or electrical component substrate is applied as a continuous web with the density of printed electrical component or antenna substrate matching the density of the labels. In a yet further embodiment, the electrical components or antennas printed or otherwise placed on the substrate may have a higher density than that of the labels. A mechanism would cut the electrical component or antenna substrate and dispense individual electrical components/antennas to synchronize with the placement of straps or inlays.

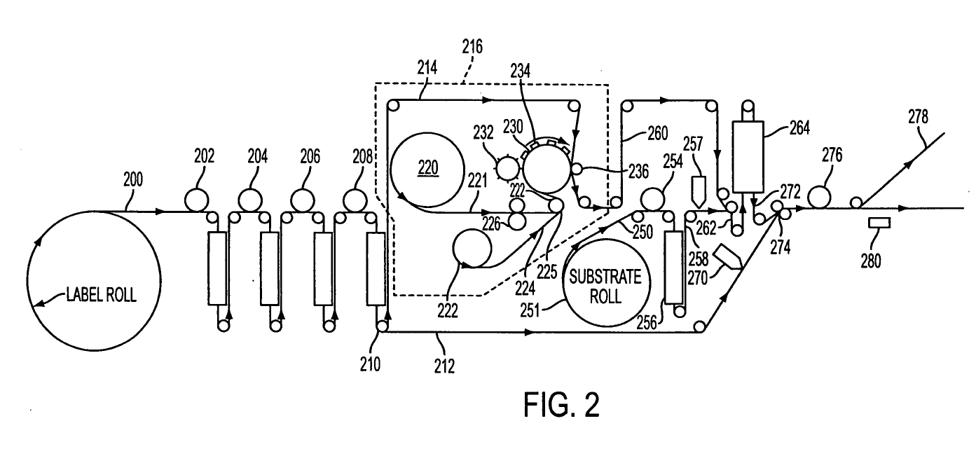

Referring now to FIG. 2, a roll of label stock 200, that in one embodiment may be pressure sensitive label stock, is unwound and may pass through any number of printing stations 202-208 to apply graphic content to the face surface of the labels. These printing stations may conveniently include ink drying/curing operations. A release liner 212 is then delaminated from the face stock at roll 210, with the liner substrate 212 traveling in a separate path relative to the label face substrate 214.

In one embodiment of a strap or inlay Insertion Module 216, a strap or inlay substrate 221 is unwound from a reel 220 and laminated at a roll 225 with a bonding tape 224 unwound from a bonding tape roll 222. The bonding tape 224 has a width sufficient to cover the IC chip 10, but substantially less than the width of the contact pads 34 and 36. In the embodiment shown in FIG. 2, the contact pads on the substrate web 221 are on either side of the IC chip 10 in the z direction coming out of the page. The bonding tape 224 is laminated down the center of the substrate 221 to cover the IC chips 10, but not substantially covering the contact pads extending laterally in the z direction. The adhesive on the bonding tape 224 attaches to the chips to provide a smooth surface. One form of bonding tape lamination is described in U.S. application Ser. No. 11/113,319 filed Apr. 25, 2005.

The strap or inlay substrate 221 is applied to a vacuum drum 230 by means of a servo-controlled strap or inlay feed roll 226. The strap or inlay substrate 221 is applied to the vacuum drum 230 with the chip side face to the drum surface. The bonding tape laminated to the chips provides a smooth, continuous surface that facilitates suction by the negative pressure of vacuum holes to hold the strap or inlay substrate 221 to the vacuum drum 230. Because the density of straps or inlays on the strap or inlay substrate 221 is almost always greater than the labels on the label face stock 214, the strap or inlay substrate 221 may be advanced at a velocity slower than the surface of the vacuum drum 230, causing the strap or inlay substrate 221 to slide on the vacuum drum 230.

A strap or inlay cut-off cylinder 232 is timed under servo control to separate individual straps or inlays 234 from the strap or inlay substrate 221. The rotating vacuum drum 230 acts as an anvil and thus typically may have a hard surface. The vacuum drum 230 positions the cut individual straps or inlays onto adhesive on the label face stock 214 between the vacuum drum 230 and a soft nip cylinder 236. The position of the straps or inlays are synchronized to the label graphics on the opposite side of the label face stock by means of the servo-driven strap feed roll 226, the servo-driven cut-off cylinder 232, and the servo-driven vacuum drum 230. In one embodiment, a photo-optic sensor is used to detect the leading edge of straps or inlays on the web 221 and perform the cutting operation with a vacuum hole/nozzle under the strap or inlay as it is being cut into a chip section. A second photo-optic sensor detects a registration mark on the labels on the webstock 214. The phases of the cut chip sections and the approaching labels on the label webstock 214 are matched and the velocity of the various rolls and drums are appropriately servo-controlled to effect positioning of the chip sections on the labels. Units for performing such pitch indexing operations are sold by Tamarack Products, Inc., Wauconda, Ill.

A separate substrate 250 is unwound from a roll 251 and passed through a station 254, to add electrical components. In one embodiment, the electrical components are antennas and the station 254 may be a printing station, such as, for example, a flexographic printing station. In the printing station embodiment, the printing station 254 prints a conductive ink in a desired pattern of an antenna which matches the radio frequency transmission characteristics for which the strap was designed, or prints a parasitic antenna with a pattern designed to yield a customized range or antenna characteristic for the inlay. The substrate with the antennas printed thereon is then passed through a drying or curing station 256 for the conductive ink to obtain the substrate 258. Then a conductive adhesive is jet-dispensed by a dispenser 257 onto electrical connection pads on the printed antennas or electrical components.

The label face stock 260 with the IC chips by themselves, or straps or inlays attached and the electrical component/antenna substrate 258 are then advanced to a common path 262, wherein the substrate 258 is laminated in synchronization to adhesive side of the label face stock 260. In the case of a strap, the electrical connection pads of the antenna or other electrical component are matched to the electrical connection pads of the IC chip on the strap and become electrically and mechanically bonded. In the case of a Cole inlay, the synchronization is such as to place the parasitic antenna in a desired adjacency with the inlay to permit electromagnetic communication therebetween. This synchronization is performed, in one embodiment, by using photo optic sensors to detect the position of the labels and chip sections on the web 260 and the positions of the electrical components on the component web 258. A phase matching is then performed to properly align the label web 260 to the component web 258 and effect matching using servo-control of the velocities of the various rolls. The combined substrate is then passed through a thermal oven 264 or other appropriate means to cure the conductive adhesive or other connection medium.

The delaminated release liner 212 passes under a nozzle 270 of a hot-melt adhesive applicator where adhesive is applied to the liner 212 at least in the areas where the original label facestock adhesive has been covered by the antenna or electrical component. The adhesive on the liner is applied in synchronization so that as the liner 212 becomes re-laminated with the combined/married label face stock and antenna or electrical component substrate 272, the hot-melt adhesive applied to the release liner is transferred to the back of the antenna substrate, making the adhesive on the back of the label face stock continuous. The re-lamination of the liner 212 to the married label/electrical component substrate 272 is accomplished by passing the liner 212 and the married facestock 272 through a nip 274 between a pair of rolls. The finished label webstock is then butt cut or die cut via a cutter roll 276 or any other convenient cutting mechanism. In a diecutting configuration, the waste matrix 278 may be re-wound on a reel. The finished labels are then passed by a reader or verification station 280 to determine the viability of the RFID or other electronic component on the label. The combined label construction may now be converted into the final finished label.

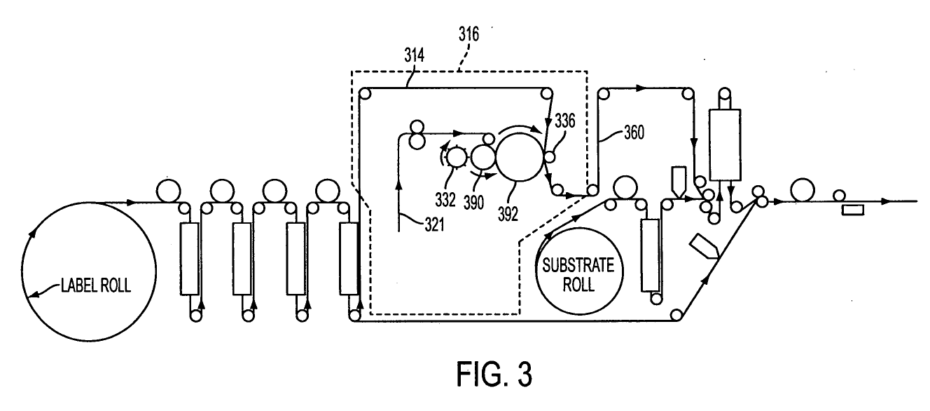

Referring to FIG. 3, there is shown a second embodiment of an apparatus and process for implementing the present invention. The apparatus and process is substantially the same as that of FIG. 2 except that the strap/inlay insertion module 316 has been altered. In the embodiment shown, the single vacuum drum of FIG. 2 has been replaced by a first vacuum drum 390 and a second vacuum drum 392. The IC chip or strap or inlay webstock may 321 may be applied to the first vacuum drum 390 that is rotating at a velocity, for example, approximately the same as the webstock 321. The strap or inlay substrate would contact the first vacuum drum oriented with the chip side away from the drum. A cutting roll 332 would then operate to cut the webstock 321 into chip sections, with the first vacuum roll 390 operating as an anvil during the cutting process. The use of the two drums allows the drum surface of the first vacuum drum 390 to travel at approximately the same velocity as the strap or inlay substrate during the cutting process, while the second vacuum drum 392 would travel at a different velocity relative to the strap or inlay substrate, as is required prior to separation, with minimal problem in order to effect indexing to the pitch of the labels on the label webstock 314. More specifically, following separation from the strap or inlay substrate 321, the cut chip sections comprising the individual straps or inlays would be transferred to a second vacuum drum 392. As previously noted, there are several ways the straps might be transferred from one vacuum drum to another. One method might transfer the strap or inlay by direct contact from one drum to another. Another transfer method might be vacuum needles such as used in flip-chip integrated circuit placement. When the chip section is transferred to the second vacuum drum 392, it would be placed chip side down, in contact with the drum 392. Since the chip section and drum 392 would be traveling at approximately the same surface velocity, there would be minimal problem in holding the chip side in contact with the drum. Because the separation (cutting) of the individual chip sections from the strap or inlay substrate 321 occurs on the first drum 390, there is no need for the second drum 392 to be constructed of hardened steel. The second drum 392 may be fabricated with a surface of flexible material that would facilitate a vacuum seal to an irregular surface. Because the second drum 392 would not be hardened metal and could be of a lower precision, it would be less expensive than the previous process required. Because the first vacuum drum 390 provides only the cutting function, it does not require a large circumference to match velocity and accumulate multiple repeats of straps or inlays. Such a drum would be smaller and less expensive than required by previous processes.

Note that it is optional to apply bonding tape to the IC chips on the webstock 321. In the FIG. 3 implementation, no bonding tape 224 is applied.

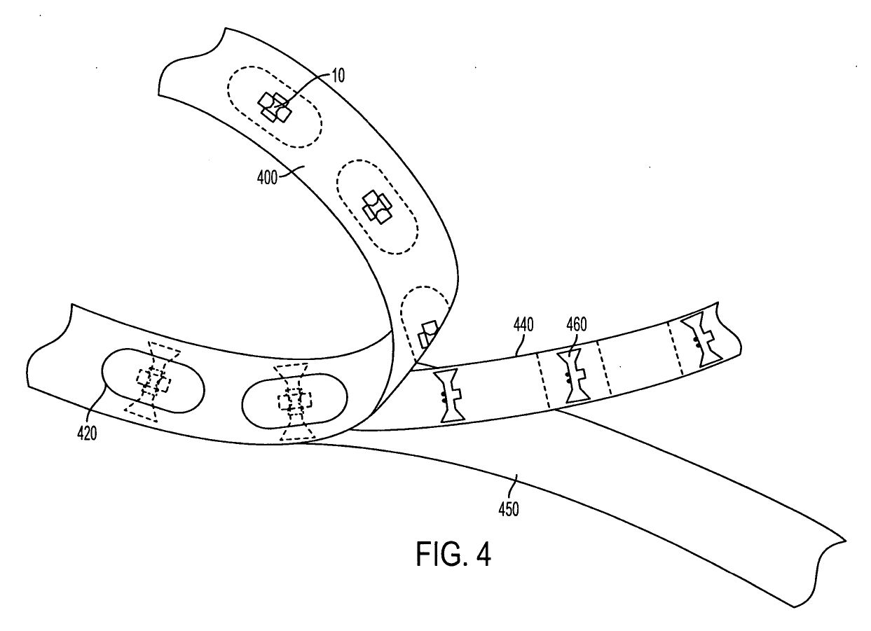

Referring to FIG. 4, there is shown a schematic diagram of one embodiment of a facestock 400 to electrical component webstock 440 marrying operation. Note that the marrying operation of this embodiment occurs after the integrated circuit chips 10, either directly or in the form of straps or inlays with or without contact pads, have been attached to the facestock 400. Note that the bonding tape over the IC chips 10 is shown as discontinuous for purposes of illustration. A printed label 420 is shown on one side of the facestock 400. In the embodiment of FIG. 4, the electrical component 460 on the substrate 440 is illustrated as an antenna. A release liner 450 may subsequently be attached to the married facestock/webstock.

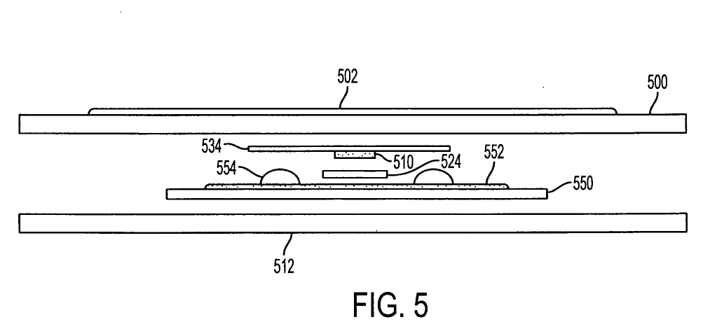

Referring now to FIG. 5, there is shown an exploded schematic cross-section diagram (in the z direction relative to FIG. 2 so that the web is moving up off of the paper) of a finished RFID label in accordance with one embodiment of the invention. The dimensions in the figure are for explanatory purposes only and are not limiting on the invention. The label facestock 500 is shown with the printed label graphics 502 on the top surface of the facestock 500, with adhesive (not shown) on the bottom side thereof. A strap or inlay 534 with an IC chip 510 is shown below the label facestock 500. Bonding tape 524 is shown applied across the chip 510. The bonding tape 524 has a width sufficient to cover the IC chip 10, but does not substantially cover the contact pads on the strap 534 on either side of the IC chip. An electrical component/antenna webstock 550 with a printed antenna 552 thereon is illustrated below the strap or inlay 534. Conductive adhesive 554 is shown for attaching the IC chip, or strap or inlay 534 to the antenna 552 or other electrical component. Note that for the Cole type inlay, the adhesive 554 does not need to be conductive.

In a further embodiment of the apparatus and process of the invention, the pitch of the antennas or other electrical components on the webstock 258 of FIG. 2 may be different from the pitch of the labels on the webstock 260. In that case, a method is provided to cut the antenna or other electrical components into sections, each component section comprising at least one antenna or electrical component disposed or otherwise provided on a portion of polymeric, paper, or other web material. Those cut antenna or other component sections would then be indexed to the pitch of the labels and attached to the labels as before. In one embodiment of such an attachment method and apparatus, the insertion modules of either FIG. 2 or FIG. 3 could be used. The antenna or other electrical component sections could be cut using a cutter roll 232/332 or a guillotine knife, by way of example. Indexing of the pitch of the cut component sections to the label web could be performed using the methods described previously or any other convenient method. A bonding tape could be used, but may not be necessary for antenna sections, depending on the size and profile of the electrical component in an electrical component section. Note that if the insertion module 316 of FIG. 3 was used, then a pick and place operation could be used.

In one embodiment of this insertion method, the cut antenna or electrical component sections would be held by the vacuum roll in FIG. 2 or in FIG. 3 and attached to the respective labels on the label webstock 260/360 at a nip between the vacuum drum and a roll.

Indexing the pitch of the antenna or electrical component sections to the label pitch would be accomplished, in one embodiment, by servo control based on a timing mark or other indicator on the labels, or by some other convenient method.

Note that the label manufacturing process may be continuous or discontinuous. The configuration of electronic ICs on a webstock may vary depending on the particulars of the IC placement process, the requirements of the RFID application (and associated specifications of the RFID chip and/or antenna), and other factors. For example, there may be a single row of small electronic IC chips along the web, or there may be multiple rows. For reasons of economy, it is typically desirable to put as many IC chips on the web as possible and for this reason small, densely packed IC's are desirable. That is, in one embodiment, the “pitch density” of the small electronic IC's is maximized.

Thus, the present method and apparatus may be utilized with a grid of IC chips arrayed longitudinally and transversely on the web. As noted, the pitch of chips (i.e. center-to-center distance between adjacent chips) may be different than the pitch of an array of RFID tags or labels to be formed: (a) in the longitudinal (also called the “down web”) direction; (b) in the transverse (or “cross web”) direction, or (c) in both directions.

Note that if a grid of chips arrayed longitudinally and transversely on the web is provided, then an IC chip or strap or inlay webstock may be slit into a series of longitudinal lanes, each containing a single row of microelectronic chips. At a later point in the process, individual chip sections can be severed or separated from these lanes to be applied to individual RFID tags or labels. Handling the chip sections is thus disclosed in one embodiment as a roll-to-roll lamination process. The lanes of the web that bears the chip sections must also be made to match the lateral (cross-web) pitch of the lanes of the web bearing the labels and/or the electrical components. One way to ensure this “cross-web alignment” is to use one independent web of chip sections for every one independent web of labels. Another approach is to slit the respective webs longitudinally, and then align the slit lanes of chip sections to the cut lanes of labels. This can be done using a series of spreader rolls, much as is done in a conventional slitter assembly. Slitting methods are known and are disclosed in a number of U.S. Patents including, for example, U.S. Pat. Nos. 3,724,737, 3,989,575, 3,891,157, 4,480,742, all incorporated herein by reference, and European Patent Publication EP 0 979 790 A2, incorporated herein by reference. The spreader rolls divert the strands of small electronic IC chip sections to provide one lane of chip sections for every lane of labels.

Note again that the size of each individual IC chip or strap or inlay section is largely independent of the size of the associated finished label. The size of the chip sections may vary as needed for given applications.

As noted for the previously described embodiment, the individual chip sections are cut or separated from the web. This cutting may be accomplished by butt cutting, die cutting or by other cutting methods in the art, such as laser cutting, perforating, slitting, punching, or other known means that can scribe to specific shapes and sizes. The cut sections are then indexed in such a way as to match the pitch of the labels or electrical components. The pitch of the labels depends on the size of the labels, which can vary from application to application. Typically, the chip sections are provided at a predetermined minimum spacing, and must be “indexed” to match the spacing that is required for the size of the particular type of label into which the chip section is to be incorporated. The indexing may affect the down-web spacing of the sections, the cross-web spacing, or both.

A servo controlled indexing device can be used to control the relative speed of the web that bears the chip sections, relative to the speed of the web bearing the labels, so as to space individual IC's appropriately with respect to the label web. This longitudinal (down-web) indexing brings the chip sections into alignment with the labels, so that a chip section is properly positioned relative to the label and can be bonded to the label.

The foregoing has assumed that the IC chips are provided on a rolled web that is unwound during the manufacturing process. However, as an alternative, the web with microchips may be provided in sheet form rather than rolled web form. The sections bearing the individual ICs would then be cut from pre-cut sheets, rather than from a roll, and these sections could be integrated into an RFID tag or label stock using a pick and place operation. To regulate the pick and place operation, the position of a chip section bearing small electronic IC's may be registered on a corresponding label by, for example, using a CCD camera to detect a registration or alignment mark on or near the label. In lieu of the web-handling equipment illustrated above (e.g. for the indexing station, and the attaching station), sheet handling equipment may be employed.

The pick and place operation may be performed by a pick and place device, which may include mechanical and/or vacuum grips to grip a section bearing a small IC chip while moving it into the desired location in alignment with the label. It will be appreciated that a wide variety of suitable pick and place devices are known. Examples of such devices are the devices disclosed in U.S. Pat. Nos. 6,145,901, and 5,564,888, both of which are incorporated herein by reference, as well as the prior art devices that are discussed in those patents.

As noted above, the webstock 258 may have attached thereto electrical components rather than or in addition to antennas. For instance, the electrical component may comprise a sensor, a MEMS, or other type of component. The components may be electrically interconnected to the IC chip or strap or inlay to form a circuit or may be connected by a capacitive coupling, or an inductive coupling. The type of electrical and/or electronic components to be used on the webstock 258 can be selected by one of ordinary skill in the art and depends on the use to be made of the circuit.

It is noted that in one embodiment, the IC chip could be positioned in a well or recess in the webstock. The RFID IC could be a “flip chip” type, wherein the die is made so that exposed contacts, or pads on the die have bumps on them. In normal flip chip packaging, the die is flipped over and contacted directly into the leads that provide electrical contacts for a circuit including the IC. RFID tag and label constructions using “flip chip” technology are available for example from KSW Microtec GmbH, Dresden Germany.

U.S. Pat. No. 6,951,596 to Green is hereby incorporated in its entirety by reference. Green discloses various embossing techniques that may be used to emboss or provide wells in the surface of the vacuum drum 230. Additionally, Green provides a compendium of prior art materials for use as the webstocks, the IC chips, the antennas, and the adhesives, as well as methods of making the antennas, cutting webstock, and attachment, which may be utilized in implementing various embodiments herein.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A method of forming an electrical component construction, comprising:
obtaining a chip webstock containing a plurality of integrated circuit chips;
obtaining a label webstock having printed label graphics thereon;
cutting the chip webstock into a plurality of chip sections, each of the chip sections including at least one integrated circuit chip;
indexing the chip sections from a high density on the chip webstock to a lower density;
attaching each of a plurality of the different chip sections on a different label on the label webstock;
obtaining an electrical component webstock comprising electrical components on a web; and
attaching each of a plurality of the electrical components relative to a different one of the integrated circuit chips on the label webstock to permit an electrical communication therebetween.

2. The method as defined in claim 1, wherein the electrical component webstock has an component pitch that is consistent with a label pitch of said label webstock; and
wherein the attaching each of the electrical components step comprises
marrying the electrical component webstock to the label webstock after the chip sections have been attached to the label webstock.

3. The method as defined in claim 2, wherein the attaching each of a plurality of the different chip sections step comprises attaching the different chip sections on a side opposite to the label graphics of the label webstock.

4. The method as defined in claim 1, wherein the attaching each of the electrical components step comprises
cutting the electrical component webstock to obtain component sections, each component section containing at least one electrical component;
indexing the pitch of the component sections to a pitch of the labels on the label webstock; and
attaching the component sections relative to a different one of the integrated circuit chips on the label webstock to permit an electrical communication therebetween.

5. The method as defined in claim 1, wherein the integrated circuit chips are RFID chips and the electrical components are antennas.

6. The method as defined in claim 1, further comprising
after obtaining the chip webstock step, attaching a bonding tape over each of a plurality of the integrated circuit chips.

7. The method as defined in claim 1, further comprising holding the cut chip sections in a continuous relief formed around a circumference of the vacuum drum in at least one of the cutting the chip webstock and indexing the chip sections steps.

8. The method as defined in claim 1, wherein for at least one of the cutting the chip webstock and indexing the chip sections steps comprises holding the cut chip sections on a vacuum drum with a chip side of the chip sections facing a drum surface of the vacuum drum.

9. The method of claim 7, further comprising advancing the chip webstock to the vacuum drum at a velocity slower than a surface speed of the vacuum drum, thereby causing the chip webstock to slide on the vacuum drum.

10. The method as defined in claim 1, wherein the cutting the chip webstock step comprises cutting the chip webstock using a first vaccum drum traveling at a first surface velocity; and
wherein the indexing the chip sections step comprises transferring the cut chip sections to a second vacuum drum traveling at a different surface velocity relative to the first vacuum drum to index a pitch of the chip sections to a pitch of the labels on the label webstock.

11. The method as defined in claim 1, wherein the cutting the chip webstock step comprises cutting the chip webstock using a knife; and
wherein the indexing the chip sections step comprises transferring the cut chip sections to a vacuum drum traveling at a surface velocity to index a pitch of the chip sections to a pitch of the labels on the label webstock.

12. The method as defined in claim 1, wherein the obtaining the electrical component webstock step comprises
printing antenna patterns on a substrate, with each antenna pattern having at least one connection pad; and
dispensing a conductive adhesive onto at least the one connection pad of the antenna patterns.

13. The method as defined in claim 1, further comprising laminating a release liner onto the electrical components on a back of the label webstock.

14. An apparatus for forming an electrical construction, comprising:
a cutting apparatus for cutting a chip webstock containing integrated circuit chips into a plurality of chip sections, each of the chip sections including at least one integrated circuit chip;
a first vacuum drum designed to receive chip sections with a side with the integrated circuit chip facing a surface of the first vacuum drum, the first vacuum drum designed for indexing the chip sections from a high density of the chip webstock to a lower density, and at a nip attaching each of a plurality of the different chip sections adjacent to a different label on the label webstock;
an electrical component attaching device for attaching or forming an electrical component on a substrate to form an electrical component webstock; and
an attaching mechanism for attaching each of a plurality of the electrical components relative to a different one of the integrated circuit chips on the label webstock to permit an electrical communication therebetween.

15. The apparatus as defined in claim 14, wherein the electrical component attaching or forming device comprises an antenna printer for printing antenna patterns on a substrate to form the electrical component webstock;

16. The apparatus as defined in claim 14, wherein the electrical component webstock has a component pitch that is consistent with a label pitch of said label webstock; and
wherein the attaching mechanism comprises a laminating roll for marrying the electrical component webstock to the label webstock after the chip sections have been attached thereto.

17. The apparatus as defined in claim 14, wherein the attaching mechanism comprises
a cutting mechanism for cutting the electrical component webstock to obtain component sections that are indexed to a pitch of the labels on the label webstock, each component section containing at least one electrical component; and
a second vacuum drum for attaching the component sections relative to a different one of the chip sections on the label webstock to permit an electrical communication therebetween.

18. The apparatus as defined in claim 17, wherein the cutting mechanism is a cutting roll.

19. The apparatus as defined in claim 17, wherein the cutting mechanism is a knife.

20. The apparatus as defined in claim 14, further comprising at least one printer for printing label graphics on a substrate web to form the label webstock.

21. The apparatus as defined in claim 14, further comprising a servo-controlled chip webstock feed mechanism for advancing the chip webstock to the first vacuum drum for cutting the chip webstock into chip sections and indexing the chip sections, the servo-controlled chip webstock feed mechanism advancing the chip webstock at a velocity slower than a surface speed of the first vacuum drum, thereby causing the chip webstock to slide on the first vacuum drum.

22. The apparatus as defined in claim 14,
wherein the cutting apparatus for cutting the chip webstock comprises a cutting roll and a third vacuum drum traveling at a first surface velocity and designed to function as an anvil for cutting the chip webstock; and
means for transferring the chip sections that are cut to first vacuum drum traveling at a different surface velocity relative to the third vacuum drum to index a pitch of the chip sections to a pitch of the labels on the label webstock.
